(19) United States
(12) Patent Application Publication
(10) Pub. No.: US 2011/0200805 A1
(43) Pub. Date: Aug. 18, 2011

(54) REINFORCED PLATE GLASS AND METHOD FOR MANUFACTURING THE SAME

(76) Inventors: Masahiro TOMAMOTO, Otsu-shi (JP); Tatsuya Takaya, Otsu-shi (JP); Hiroshi Takimoto, Otsu-shi (JP)

(21) Appl. No.: 13/010,088

(22) Filed: Jan. 20, 2011

(30) Foreign Application Priority Data
Feb. 12, 2010 (JP) 2010-028882

(51) Int. Cl. B32B 17/00; C03B 23/203; B32B 7/02; C03B 23/037

(52) U.S. Cl. 428/213; 65/41

(57) ABSTRACT

Provided is a method, including: performing heat treatment, under a state in which a thick core plate glass (2a) having a higher thermal expansion coefficient and a thin surface-layer plate glass (3a) having a lower thermal expansion coefficient are laminated together, so that the laminated portion has a temperature equal to or higher than the lower softening point out of the softening points of the core plate glass (2a) and the surface-layer plate glass (3a), thereby melt-bonding the core plate glass (2a) and the surface-layer plate glass (3a); and then performing cooling so as to attain a temperature less than the lower strain point out of strain points of the core plate glass (2a) and the surface-layer plate glass (3a), to thereby form a compression stress in a surface layer portion (3) corresponding to the surface-layer plate glass (3a) and form a tensile stress in a core portion (2) corresponding to the core plate glass (2a).

### TECHNICAL FIELD

The present invention relates to a reinforced plate glass used for a substrate material, a cover glass member, or the like to be mounted on, for example, an image display portion or an image input portion of various kinds of portable information terminals typified by a mobile phone and a PDA and an electronic appliance typified by a liquid crystal display, or on a solar light inlet of a solar cell, and to a method for manufacturing the same.

### BACKGROUND ART

As is known well, progress has been continuously made in recent years in technological innovation regarding various kinds of information-related terminals, for example, portable appliances such as a mobile phone, a digital camera, and a PDA or an image display apparatus such as a liquid crystal television. Such information-related terminals include a transparent substrate mounted thereon, as a substrate material for displaying information such as images and characters or for inputting information with a touch panel display or the like, or as a cover member. Moreover, in addition to the above-mentioned portions of the information-related terminals, a transparent substrate is installed in, for example, a solar light inlet of a solar cell. Those transparent substrates are required to secure reduction of environmental load and high reliability, and hence glass is adopted as a material for the transparent substrates.

Glass substrates used for applications of those kinds are required to have high mechanical strength and to be thin and light. In view of the foregoing, as a glass substrate meeting such demands, Patent Literature 1 discloses a so-called reinforced plate glass produced by subjecting surfaces of a plate glass to chemical strengthening by ion exchange or the like. For example, when a TFT device is formed on the reinforced plate glass of this kind, the original glass is desirably free of alkali metals. However, there is a problem in that if alkali-free glass is used for satisfying the demands as mentioned above, the above-mentioned chemical strengthening cannot be realized.

On the other hand, Patent Literature 2 discloses that a laminate substrate in which a plurality of plate glasses are laminated includes a transparent glass core having a higher thermal expansion coefficient and a pair of transparent glass skin layers each having a lower thermal expansion coefficient and being arranged at outermost layers on one of both sides of the transparent glass core in its plate thickness direction, thereby forming a compression stress in the transparent glass skin layers and a tensile stress in the transparent glass core.

According to this laminate substrate, the compression stress in the transparent glass skin layers may cause the substrate to produce stored energy for enhancing resistance to the occurrence and propagation of flaws, without any restriction regarding the materials of the plate glasses. Thus, it is expected that the laminate substrate may contribute to preventing the breakage of the substrate.

### CITATION LIST

### Patent Literature

Patent Literature 1: JP 2006-83045 A
Patent Literature 2: JP 2008-522950 A

### SUMMARY OF INVENTION

### Technical Problem

By the way, in the laminate substrate forming the reinforced plate glass disclosed in Patent Literature 2 described above, it is required to form a compression stress in a surface layer portion and a tensile stress in a core portion. Thus, as described in paragraph [0062] in the same literature, it is said to be advantageous to perform lamination while molten glass is being formed into a sheet shape, in order to attain sufficient bonding between adjacent layers.

However, if such a lamination technique as described above is adopted, work for lamination must be carried out in the midst of a process of forming a plate glass in which molten glass is formed into a sheet shape. Thus, the lamination work of high-temperature glass sheets that are continuously delivered becomes extremely troublesome and cumbersome, resulting in inevitable deterioration of workability.

Moreover, when the lamination work described above is carried out, not only is the cost of work equipment increased, but a work region (work site) is limited, and hence there is a fatal problem in that the degree of freedom in the work becomes extremely small because a space necessary for the work cannot be sufficiently secured or the work is strictly restricted by the temperature and atmosphere of the work region.

Moreover, in the lamination work described above, when the kind of the reinforced plate glass is changed, the glass materials thereof in a melting furnace must be replaced by other ones, which requires large-scale work. Thus, the lamination work described above also has a serious problem in that the kind of the reinforced plate glass cannot be easily changed, and hence it is extremely difficult to cope with frequent changes of the kind of the reinforced plate glass.

In consideration of the above-mentioned circumstances, a technical object of the present invention is to enable easy implementation of lamination work by using simple equipment in manufacturing a reinforced plate glass by laminating a plurality of plate glasses, and to enable changes of the kind of the reinforced plate glass to take place in a simple manner, thereby attaining the reduction of the cost of equipment and the reduction of production cost.

### Solution to Problem

A method for manufacturing a reinforced plate glass according to the present invention, which has been invented to solve the above-mentioned technical problem, includes performing heat treatment, under a state in which a thick core plate glass having a higher thermal expansion coefficient and a thin surface-layer plate glass having a lower thermal expansion coefficient are laminated together, so that the laminated portion has a temperature equal to or higher than a lower softening point out of softening points of the core plate glass and the surface-layer plate glass, thereby melt-bonding the core plate glass and the surface-layer plate glass; and then performing cooling so as to attain a temperature less than a lower strain point out of strain points of the core plate glass and the surface-layer plate glass, to thereby form a compression stress in a surface layer portion corresponding to the surface-layer plate glass and form a tensile stress in a core portion corresponding to the core plate glass.

According to the configuration described above, already formed plate glasses are used as a core plate glass and a surface-layer plate glass, and those plate glasses are melt-bonded to each other by performing heat treatment to the core plate glass and the surface-layer plate glass under the state in which the core plate glass and the surface-layer plate glass are laminated together. Thus, work for melt-bonding the core plate glass and the surface-layer plate glass is eliminated in the execution of a process of forming a plate glass in which molten glass is formed into a sheet shape. As a result, a situation where the melt-bonding work is strictly restricted is avoided, and the degree of freedom in the work becomes larger. In addition, the simplification of work equipment, the reduction of the cost of the work equipment, and the reduction of production cost are attained, and moreover, the improvement of workability and productivity is attained. Besides, even in the case where the kind of a reinforced plate glass to be produced is changed, large-scale changes of equipment and work are not required, and it is possible to easily and promptly cope with the change of the kind of the reinforced plate glass. In addition to the provision of the above-mentioned advantages, there can also be provided the advantage that it is possible to perform work such as very precise fine adjustment while causing thermal changes in a broad range in the process in which the core plate glass and the surface-layer plate glasses are heated to a temperature equal to or higher than the lower softening point out of the softening points of the core plate glass and the surface-layer plate glasses, thereby melt-bonding the core plate glass and the surface-layer plate glasses, and the core plate glass and the surface-layer plate glasses are cooled to a temperature less than the lower strain point out of the strain points of the core plate glass and the surface-layer plate glass. Therefore, in the reinforced plate glass provided by the manufacturing method, a tensile stress formed in the core portion corresponding to the core plate glass and a compression stress formed in the surface layer portion corresponding to the surface-layer plate glass can be adjusted precisely by a simple technique so as to strike a proper balance. As a result, the method can contribute to providing high quality to a reinforced plate glass.

In the above-mentioned configuration, the core plate glass and the surface-layer plate glass may be melt-bonded by performing heat treatment so that the core plate glass and the surface-layer plate glass each have a temperature equal to or higher than the higher softening point out of the softening points of the core plate glass and the surface-layer plate glass.

With this, the core plate glass and the surface-layer plate glass are melt-bonded more reliably, and hence the strength against the detachment of the core plate glass and the surface-layer plate glass can be enhanced. Note that, it is preferred that the core plate glass having the higher thermal expansion coefficient have a lower softening point than the surface-layer plate glass having the lower thermal expansion.

In the configuration described above, it is possible to use, as a technique for melt-bonding the core plate glass and the surface-layer plate glass, down-draw (a redraw method) under the state in which the core plate glass and the surface-layer plate glass are laminated together.

In the down-draw, a core plate glass and surface-layer plate glass obtained after primary forming are used as preforms, and the core plate glass and the surface-layer plate glass are melt-bonded by drawing them down while performing heat treatment in a heating region under the state in which the core plate glass and the surface-layer plate glass are laminated together, followed by cooling such as annealing, to thereby yield a reinforced plate glass. Further, the heating region is divided into, for example, beginning from the top, a preheating zone, a forming zone, and an annealing zone, and down-draw or stretch forming can be carried out while breakage or the like caused by a thermal shock in heating the preforms is effectively suppressed, and hence it is possible to produce smoothly and precisely a reinforced plate glass having an extremely thin thickness compared to the thickness of the preforms. Besides, when the surface-layer plate glass is heated to a temperature equal to or higher than the softening point thereof, the surface-layer plate glass can be smoothly stretched downward. Thus, even if the surface of the surface-layer plate glass have flaws and waviness, the flaws and waviness can be properly reduced or eliminated.

If the redraw method is adopted as described above, when the laminated plate glass is drawn under heating, it is preferred that rotation rollers aligned at fixed positions in the width direction of the laminated plate glasses each hold the laminated plate glasses at both side edge portions in the width direction and draw the laminated plate glasses downward.

With this, because there is maintained the state in which the rotation rollers aligned at fixed positions in the width direction of the core plate glass and the surface-layer plate glass each hold the plate glasses at both the side portions in the width direction when the plate glasses are drawn by being softened by heating and drawn downward, the softened plate glasses (including a glass plate laminate produced by melt-bonding the core plate glass and the surface-layer plate glass) are prevented from contracting in the width direction by the hold of the rotation rollers even if the softened plate glasses are liable to contract in the width direction. As a result, even though a reinforced plate glass finally obtained is made thin, the width of the reinforced plate glass is kept at a predetermined length, and it is possible to easily produce a thin reinforced plate glass having a large width. In addition, even though the core plate glass and the surface-layer plate glass (including a glass plate laminate produced by melt-bonding the core plate glass and the surface-layer plate glass) are drawn downward, the rotation rollers accordingly rotate, and hence inconvenience such as flaws on the core plate glass and the surface-layer plate glass caused by sliding of the surface-layer plate glasses including the core plate glass and the rotation rollers relative to each other may be avoided.

In the above-mentioned configuration, it is preferred that the drop down rate of the core plate glass and the surface-layer plate glass (including a glass laminate produced by melt-bonding the core plate glass and the surface-layer plate glass) in association with changing a rotation rate of each of the rotation rollers, to thereby adjust a thickness of a reinforced plate glass finally obtained.

With this, the thickness of the reinforced plate glass finally obtained can be adjusted to a desired value by merely changing the rotation rate of each of the rotation rollers, and hence the thickness can be easily controlled.

Further, when the redraw method is adopted, the thickness of the reinforced plate glass finally obtained can be adjusted to a thickness equal to or less than half the total thickness of the laminated plate glasses.

That is, if the redraw method is adopted to produce the reinforced plate glass, it is possible to produce, without forming a thin core plate glass and thin surface-layer plate glass by primary forming, but by down-draw under heating by the redraw method, a reinforced plate glass having a thickness equal to or less than half (a thickness equal to or less than one tenth or equal to or less than one hundredth is also possible) the total thickness of a laminate of the core plate glass and surface-layer plate glass formed by primary forming. Therefore, it is possible to easily produce an extremely thin reinforced plate glass in a secondary forming process by the redraw method while enabling simplification in forming the plate glasses in the primary forming process.

In the above-mentioned configuration, it may be possible that the surface-layer plate glass is formed of one plate glass or a laminated plate glass including a plurality of plate glasses being laminated together, and the core plate glass is formed of one plate glass or a laminated plate glass including a plurality of plate glasses being laminated together; and the surface-layer plate glass is arranged on both sides of the core plate glass in a thickness direction.

That is, the reinforced plate glass may have a configuration in which a surface-layer plate glass formed of one plate glass is arranged on both sides of a core plate glass in the thickness direction, may have a configuration in which a surface-layer plate glass formed of a laminated plate glass including a plurality of plate glasses being laminated together is arranged on both sides of a core plate glass in the thickness direction, may have a configuration in which the surface-layer plate glass is arranged on both sides of a core plate glass formed of one plate glass in the thickness direction, or may have a configuration in which the surface-layer plate glass is arranged on both sides of a core plate glass formed of a laminated plate glass including a plurality of plate glasses being laminated together in the thickness direction. In this case, as a technique for producing the laminated plate glass including a plurality of plate glasses being laminated together, for each of the surface-layer plate glass and the core plate glass, the same technique including the above-mentioned redraw method as that in the present invention may be adopted, or other techniques may also be adopted.

In the above-mentioned configuration, it is preferred that the surface-layer plate glass has a thickness equal to or less than one third of the thickness of the core plate glass.

With this, it is possible to avoid a situation in which the balance between a compression stress formed in the surface layer portion corresponding to the surface-layer plate glasses and a tensile stress formed in the core portion corresponding to the core plate glass is improperly impaired. Thus, a reinforced plate glass in which proper reinforcement treatment is provided without any warpage can be obtained.

In the above-mentioned configurations, the surface-layer plate glass preferably has a thickness of 300 μm or less.

With this, even the surface-layer plate glass having a thickness of 300 μm or less can be melt-bonded to the core plate glass satisfactorily. In particular, when the above-mentioned redraw method is adopted, the thickness of the surface-layer plate glass after being melt-bonded can be made thinner. That is, even if the surface layer portion of a reinforced plate glass finally obtained eventually becomes extremely thin, the reinforced plate glass can be produced in high quality without any problem, because the surface layer portion is originally made of a plate glass and improper change of thickness and improper strain do not occur in the plate glass. Note that the upper limit of the thickness of the surface-layer plate glass can be set to 300 μm or 100 μm, and the lower limit thereof can be set to 1 μm or 5 μm.

A reinforced plate glass according to the present invention, which has been invented to solve the above-mentioned technical problem, is obtained by performing heat treatment, under a state in which a thick core plate glass having a higher thermal expansion coefficient and a thin surface-layer plate glass having a lower thermal expansion coefficient are laminated together, so that the laminated portion has a temperature equal to or higher than a lower softening point out of softening points of the core plate glass and the surface-layer plate glass, thereby melt-bonding the core plate glass and the surface-layer plate glass; and then performing cooling so as to attain a temperature less than a lower strain point out of strain points of the core plate glass and the surface-layer plate glass, to thereby form a compression stress in a surface layer portion corresponding to the surface-layer plate glass and form a tensile stress in a core portion corresponding to the core plate glass.

The description items of the reinforced plate glass having this configuration, including its functional effects, are substantially the same as the above-mentioned description items of the method according to the present invention, the method including substantially the same configurational elements as the reinforced plate glass.

### Advantageous Effects of Invention

As described above, according to the present invention, already formed plate glasses are used as the core plate glass and the surface-layer plate glasses, and those plate glasses are melt-bonded to each other by performing heat treatment to the core plate glass and the surface-layer plate glass under the state in which the core plate glass and the surface-layer plate glass are laminated together. Thus, work for melt-bonding the core plate glass and the surface-layer plate glass is eliminated in the execution of a process of forming a plate glass in which molten glass is formed into a sheet shape. As a result, the situation where the melt-bonding work is strictly restricted is avoided, and the degree of freedom in the work becomes larger. In addition, the simplification of work equipment, the reduction of the cost of the work equipment, and the reduction of production cost are attained, and moreover, the improvement of workability and productivity is attained. Besides, even in the case where the kind of a reinforced plate glass to be produced is changed, large-scale changes of equipment and work are not required, and it is possible to easily and promptly cope with the change of the kind of the reinforced plate glass.

### BRIEF DESCRIPTION OF DRAWINGS

FIG. 1 is a cross-sectional view illustrating a reinforced plate glass according to an embodiment of the present invention.

FIG. 2a is a schematic view illustrating an operational status of a method for manufacturing a reinforced plate glass according to the embodiment of the present invention.

FIG. 2b is a schematic view illustrating an operational status of the method for manufacturing a reinforced plate glass according to the embodiment of the present invention.

FIG. 3 is a schematic side view illustrating an operational status of a method for manufacturing a reinforced plate glass according to another embodiment of the present invention.

FIG. 4 is a schematic side view illustrating an operational status of the method for manufacturing a reinforced plate glass according to the above-mentioned another embodiment of the present invention.

FIG. 5 is a schematic front view illustrating still an operational status of the method for manufacturing a reinforced plate glass according to the above-mentioned another embodiment of the present invention.

### DESCRIPTION OF EMBODIMENTS

Hereinafter, embodiments of the present invention are described based on the accompanying drawings.

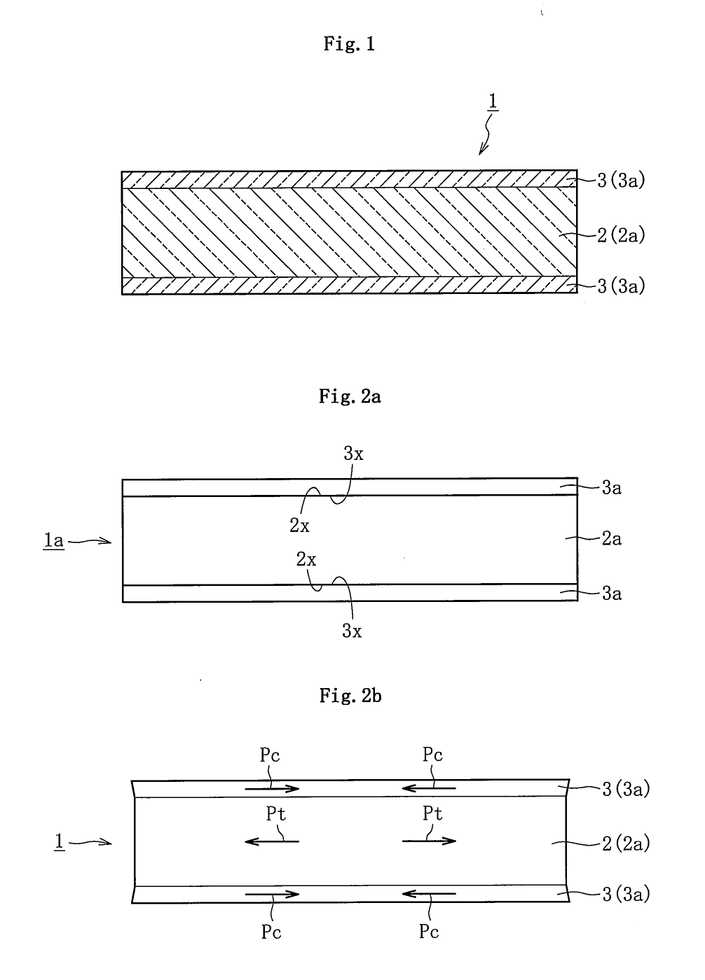

FIG. 1 illustrates a reinforced plate glass 1 according to an embodiment of the present invention. The reinforced plate glass 1 is, for example, a reinforced plate glass to be mounted on an electronic device such as a touch panel, a display, or a solar cell, the reinforced plate glass being required particularly for outdoor installation.

As illustrated in the figure, the reinforced plate glass 1 is a glass laminate which has a three-layer structure formed of a core portion 2 corresponding to a core plate glass 2a and surface layer portions 3 corresponding to surface-layer plate glasses 3a each arranged on one of both surface sides of the core plate glass 2a in its thickness direction. That is, the reinforced plate glass 1 is one obtained by closely fixing one core plate glass 2a forming the core portion 2 and two surface-layer plate glasses 3a forming the surface layer portions 3 by melt-bonding under the state in which the core plate glass 2a is sandwiched by the surface-layer plate glasses 3a.

In the reinforced plate glass 1, the surface layer portions 3 should be relatively thinner than the core portion 2, and the thickness of the surface layer portions 3 is preferably equal to or less than one third of the thickness of the core portion 2, more preferably equal to or less than one tenth, still more preferably equal to or less than one fifties. Besides, the thermal expansion coefficient of the core portion 2 should be larger than the thermal expansion coefficient of each of the surface layer portions 3, and a difference in thermal expansion coefficient between the core portion 2 and each of the surface layer portions 3 at 30 to 380° C. is set to 5×10⁻⁷/° C. to 50˜10⁻⁷/° C. Further, as illustrated in FIG. 2b, a compression stress Pc of 50 to 350 MPa is formed in each of the surface layer portions 3 and a tensile stress Pt of 1 to 100 MPa is formed in the core portion 2.

Further, the surface layer portions 3 are each made up of glass containing substantially no alkali metal oxides as its glass composition, and the core portion 2 is made up of glass containing substantially no alkali metal oxides as its glass composition or glass substantially containing alkali metal oxides as its glass composition. The phrase “containing substantially no alkali metal oxides” specifically refers to the state in which the content of alkali metal oxides is 1,000 ppm or less. The content of alkali metal oxides in each of the surface layer portions 3 and the core portion 2 is preferably 500 ppm or less, more preferably 300 ppm or less.

Further, the reinforced plate glass 1 is approximately formed as described below. That is, the reinforced plate glass 1 is manufactured by performing heat treatment, under the state in which a thick core plate glass 2a having a higher thermal expansion coefficient and thin surface-layer plate glasses 3a each having a lower thermal expansion coefficient are laminated together, so that the laminated portions have a temperature equal to or higher than the lower softening point out of softening points of the core plate glass 2a and the surface-layer plate glasses 3a, thereby melt-bonding both the core plate glass 2a and the surface-layer plate glasses 3a, and then performing cooling so as to attain a temperature lower than the lower strain point out of strain points of the core plate glass 2a and the surface-layer plate glasses 3a, to thereby form a compression stress Pc in each of surface layer portions 3 corresponding to the surface-layer plate glasses 3a and form a tensile stress Pt in a core portion 2 corresponding to the core plate glass 2a.

A manufacturing method serving as a basic concept of the reinforced plate glass 1 is described. First, as illustrated in FIG. 2a, each of bonding surfaces 2x of one core plate glass 2a and a bonding surface 3x of each of two surface-layer plate glasses 3a are brought into surface-to-surface contact at, for example, room temperature of 20° C., thereby laminating those plate glasses 2a and 3a to form three layers. Further, each relative position between those plate glasses 2a and 3a is accurately adjusted at this time. In this case, the thickness of the core plate glass 2a is 5 to 1,000 μm and the thickness of the surface-layer plate glasses 3a is 1 to 300 μm.

Next, heat treatment is applied, in a furnace such as an electric furnace, to the glass plate laminate 1a produced by, as described above, laminating the core plate glass 2a and the surface-layer plate glasses 3a together to form three layers. Then, when the temperature of each surface-to-surface contact portion (laminated portion) between the core plate glass 2a and the surface-layer plate glasses 3a reaches a temperature equal to or higher than the lower softening point (for example, 750° C. to 900° C.) out of the softening points of the core plate glass 2a and the surface-layer plate glasses 3a, that is, a temperature equal to or higher than the softening point of the core plate glass 2a having a higher thermal expansion coefficient, the adjacent bonding surfaces 2x and 3x of the core plate glass 2a and the surface-layer plate glasses 3a each are brought into a mutually melt-bonded state.

To the glass plate laminate 1a in the state described above, cooling (preferably annealing) is performed so that its temperature reaches below the lower strain point (for example, 400° C. to 500° C.) out of the strain points of the core plate glass 2a and the surface-layer plate glasses 3a. As a result, as illustrated in FIG. 2b, a reinforced plate glass 1 is obtained in which a tensile stress Pt is formed in a core portion 2 corresponding to the core plate glass 2a, and a compression stress Pc is formed in each of surface layer portions 3 corresponding to the surface-layer plate glasses 3a. Note that, the glass plate laminate 1a may be heated so as to have a temperature equal to or higher than the higher softening point (for example, 900° C. to 1,050° C.) out of the softening points of the core plate glass 2a and the surface-layer plate glasses 3a. Also note that, the surface-layer plate glasses 3a and the core plate glass 2a do not turn to molten glass or a state similar to the molten state in the above-mentioned heating in a furnace.

According to the manufacturing method described above, already formed plate glasses are used as the core plate glass 2a and the surface-layer plate glasses 3a, and those plate glasses 2a and 3a are melt-bonded to each other by performing heat treatment to the core plate glass 2a and the surface-layer plate glasses 3a under the state in which the core plate glass 2a and the surface-layer plate glasses 3a are laminated together. Thus, such work for melt-bonding plate glasses as those performed in conventional methods is eliminated in the execution of a process of forming a plate glass in which molten glass is formed into a sheet shape. As a result, a situation where the melt-bonding work is strictly restricted is avoided, and the degree of freedom in the work becomes larger. In addition, the simplification of work equipment, the reduction of the cost of the work equipment, the reduction of production cost, and the improvement of workability and productivity are attained. Besides, even in the case where the kind of a reinforced plate glass to be produced is changed, large-scale changes of equipment and work are not required, and it is possible to easily and promptly cope with the change of the kind of the reinforced plate glass.

In addition to the provision of the above-mentioned advantages, it is possible to perform work such as very precise fine adjustment while causing thermal changes in a broad range in the process in which the core plate glass 2a and the surface-layer plate glasses 3a are heated to a temperature equal to or higher than the lower softening point (or equal to or higher than the higher softening point) out of the softening points of the core plate glass 2a and the surface-layer plate glasses 3a, thereby melt-bonding the core plate glass 2a and the surface-layer plate glasses 3a, and the core plate glass 2a and the surface-layer plate glasses 3a are cooled to a temperature less than the lower strain point out of the strain points of the core plate glass 2a and the surface-layer plate glasses 3a. Therefore, in the reinforced plate glass 1 provided by the manufacturing method, a tensile stress Pt formed in the core portion 2 corresponding to the core plate glass 2a and a compression stress Pc formed in each of the surface layer portions 3 corresponding to the surface-layer plate glasses 3a can be adjusted precisely by a simple technique so as to strike a proper balance. As a result, the method can contribute to providing high quality to the reinforced plate glass 1.

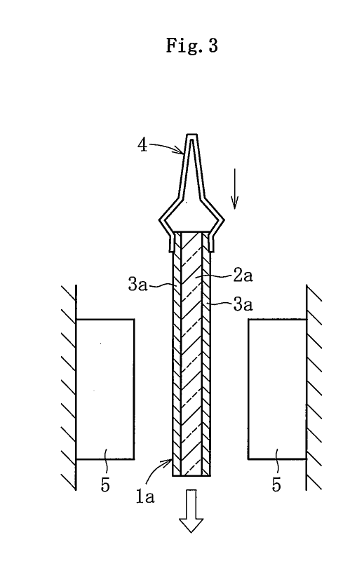

FIGS. 3 to 5 each illustrate an operational status of a method for manufacturing a reinforced plate glass according to another embodiment of the present invention. Note that, when this embodiment is described, the same reference signs as those used in the embodiment already described above are used for the configurational elements common with those of the embodiment already described above.

As illustrated in FIGS. 3 to 5, this method for manufacturing a reinforced plate glass 1 adopts a redraw method. That is, in order to produce the reinforced plate glass 1 by adopting the redraw method, as illustrated in FIG. 3, surface-layer plate glasses 3a serving as preforms are each arranged first on one of both sides in the thickness direction of a core plate glass 2a serving as another preform, to thereby temporarily produce a glass plate laminate 1a. Further, the glass plate laminate 1a is held by a holding member 4 at the top end portion so as to be hung and supported in a vertical posture. Then, the holding member 4 is moved down, thereby delivering the glass plate laminate 1a downward at a predetermined speed and inserting the glass plate laminate 1a between a pair of heaters 5.

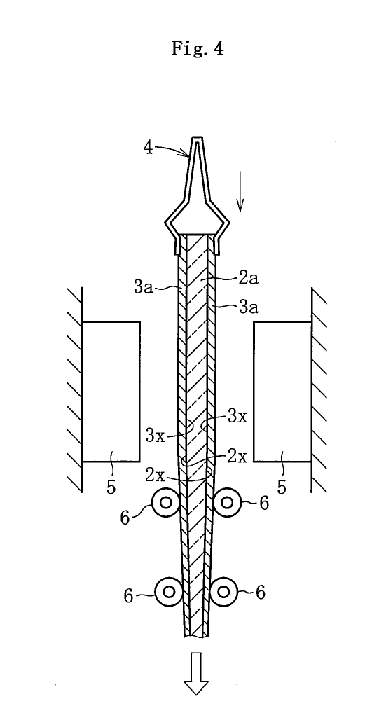

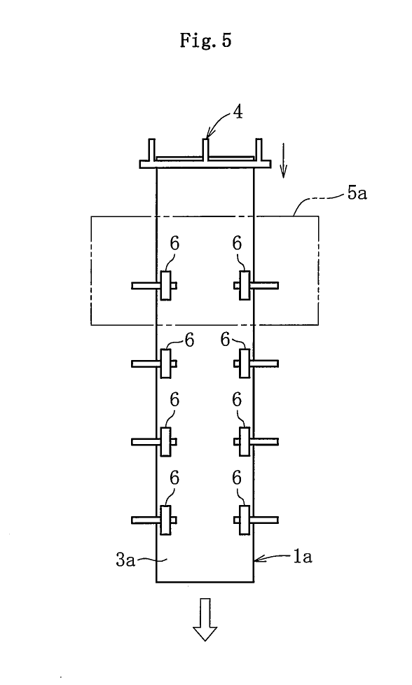

Then, as illustrated in FIGS. 4 and 5, when the lower portion of the glass plate laminate 1a is softened by being heated with each of the heaters 5 from both outer sides in the thickness direction of the glass plate laminate 1a, the glass plate laminate 1a is drawn downward, while being held, by a pair of or a plurality pairs of rotation rollers 6 arranged at one or a plurality of levels from a position corresponding to the lower portion of each of the heaters 5 downward. Each pair of the rotation rollers 6 are, in order to hold each of both side edge portions in the width direction of the glass plate laminate 1a, arranged at each level along the side edge portions under a state in which their movement in the width direction is restricted. Note that, the configurations, the characteristics, and the like of the core plate glass 2a and surface-layer plate glasses 3a are the same as those in the embodiment already described above.

In this case, though not shown in those figures, a preheating region (preheating zone) is provided immediately above a heating region (heating zone) 5a heated with the heaters 5, and an annealing region (annealing zone) is provided immediately below the heating region 5a. In the heating region 5a heated with the heaters 5, the glass plate laminate 1a (strictly speaking, each surface-to-surface contact portion between the core plate glass 2a and the surface-layer plate glasses 3a) is heated so as to have a temperature equal to or higher than the lower softening point (for example, 750° C. to 900° C.) out of softening points of the core plate glass 2a and the surface-layer plate glasses 3a, that is, a temperature equal to or higher than the softening point of the core plate glass 2a. Note that, the heating temperature in this case may be equal to or higher than the higher softening point (for example, 900° C. to 1,050° C.) out of the softening points of the core plate glass 2a and the surface-layer plate glasses 3a, that is, equal to or higher than the softening point of the surface-layer plate glasses 3a.

Further, the glass plate laminate 1a is drawn by the rotation rollers 6a under the heating conditions described above, and hence the glass plate laminate 1a is drawn (stretched) under the state in which the adjacent bonding surfaces 2x and 3x of the core plate glass 2a and surface-layer plate glasses 3a forming the glass plate laminate 1a are mutually melt-bonded. The surface-layer plate glasses 3a are particularly stretched under the temperature conditions described above, and hence flaws and waviness of the surfaces of the surface-layer plate glasses 3a are reduced or eliminated.

In addition, as illustrated in FIG. 5, because the rotation rollers 6 each hold the glass plate laminate 1a at both side edge portions in the width direction and draw it downward when the glass plate laminate 1a is softened by heating and is drawn downward, the softened glass plate laminate 1a is prevented from contracting in the width direction by the hold of the rotation rollers 6 even if the softened glass plate laminate 1a is liable to contract in the width direction. As a result, even though the reinforced plate glass 1 finally obtained is made thin by using the redraw method, the width of the reinforced plate glass 1 is kept at a predetermined length, and a thin reinforced plate glass 1 having a large width is easily produced. In addition, even though the glass plate laminate 1a is stretched by being drawn downward, the rotation rollers 6 accordingly rotate, and hence inconvenience such as flaws on the glass plate laminate 1a (in particular, surface-layer plate glasses 3a) caused by sliding of the glass plate laminate 1a and the rotation rollers 6 relative to each other is avoided.

After that, the stretched glass plate laminate 1a is subjected to annealing treatment in the annealing region so that the glass plate laminate 1a is cooled to have a temperature less than the lower strain point (for example, 400° C. to 500° C.) out of the strain points of the core plate glass 2a and the surface-layer plate glasses 3a. Then, the glass plate laminate 1a is cut at predetermined positions in the length direction, yielding a reinforced plate glass 1 which have such a thin thickness as to be equal to or less than half, equal to or less than one fifth, or equal to or less than on tenth the total thickness of the original glass plate laminate 1a produced temporarily. That is, provided is a reinforced plate glass 1 in which, as illustrated in FIG. 1, a tensile stress is formed in the core portion 2 corresponding to the core plate glass 2a and a compression stress is formed in each of the surface layer portions 3 corresponding to the surface-layer plate glasses 3a.

In the case of such method for manufacturing a reinforced plate glass 1 by using the redraw method as well, such work for melt-bonding plate glasses as those performed in conventional methods is eliminated in the execution of a primary forming process of a plate glass in which molten glass is formed into a sheet shape. Moreover, substantially the same functional effects as those described in the embodiment already described above can be obtained.

Note that, in the above-mentioned embodiment, the core portion 2 in the reinforced plate glass 1 is formed by one core plate glass 2a, but two or more core plate glasses 2a may be used to form a core portion 2 having a plurality of layers, or alternatively or additionally, two or more surface-layer plate glasses 3a may be used to form a surface layer portion 3 having a plurality of layers for each of the two surface layer portions 3.

### REFERENCE SIGNS LIST

1 reinforced plate glass
1a glass plate laminate
2 core portion
2a core plate glass
2x bonding surface of core plate glass
3 surface layer portion
3a surface-layer plate glass
3x bonding surface of surface-layer plate glass
4 holding member
5 heater
6 rotation roller
Pc compression stress
Pt tensile stress

1. A method for manufacturing a reinforced plate glass, comprising:
performing heat treatment, under a state in which a thick core plate glass having a higher thermal expansion coefficient and a thin surface-layer plate glass having a lower thermal expansion coefficient are laminated together, so that the laminated portion has a temperature equal to or higher than a lower softening point out of softening points of the core plate glass and the surface-layer plate glass, thereby melt-bonding the core plate glass and the surface-layer plate glass; and
then performing cooling so as to attain a temperature less than a lower strain point out of strain points of the core plate glass and the surface-layer plate glass, to thereby form a compression stress in a surface layer portion corresponding to the surface-layer plate glass and form a tensile stress in a core portion corresponding to the core plate glass.

2. The method for manufacturing a reinforced plate glass according to claim 1, wherein the core plate glass and the surface-layer plate glass are melt-bonded by performing heat treatment so that the laminated portion has a temperature equal to or higher than a higher softening point out of the softening points of the core plate glass and the surface-layer plate glass.

3. The method for manufacturing a reinforced plate glass according to claim 1, wherein the core plate glass and the surface-layer plate glass are melt-bonded by down-draw under a state in which the core plate glass and the surface-layer plate glass are laminated together.

4. The method for manufacturing a reinforced plate glass according to claim 3, wherein, when the laminated core plate glass and surface-layer plate glass are drawn under heating, the laminated core plate glass and surface-layer plate glass are held at both side edge portions in a width direction by each of rotation rollers aligned at fixed positions in the width direction and are drawn downward by each of the rotation rollers.

5. The method for manufacturing a reinforced plate glass according to claim 4, wherein a drop down rate of the core plate glass and the surface-layer plate glass is changed in association with changing a rotation rate of each of the rotation rollers, to thereby adjust a thickness of a reinforced plate glass finally obtained.

6. The method for manufacturing a reinforced plate glass according to claim 5, wherein a thickness of the reinforced plate glass finally obtained is equal to or less than half a total thickness of the laminated core plate glass and surface-layer plate glass.

7. The method for manufacturing a reinforced plate glass according to claim 1, wherein:
the surface-layer plate glass comprises one plate glass or a laminated plate glass including a plurality of plate glasses being laminated together, and the core plate glass comprises one plate glass or a laminated plate glass including a plurality of plate glasses being laminated together; and
the surface-layer plate glass is arranged on both sides of the core plate glass in a thickness direction.

8. The method for manufacturing a reinforced plate glass according to claim 1, wherein the surface-layer plate glass has a thickness equal to or less than one third of the thickness of the core plate glass.

9. A reinforced plate glass, which is obtained by:
performing heat treatment, under a state in which a thick core plate glass having a higher thermal expansion coefficient and a thin surface-layer plate glass having a lower thermal expansion coefficient are laminated together, so that the laminated portion has a temperature equal to or higher than a lower softening point out of softening points of the core plate glass and the surface-layer plate glass, thereby melt-bonding the core plate glass and the surface-layer plate glass; and
then performing cooling so as to attain a temperature less than a lower strain point out of strain points of the core plate glass and the surface-layer plate glass, to thereby form a compression stress in a surface layer portion corresponding to the surface-layer plate glass and form a tensile stress in a core portion corresponding to the core plate glass.

10. The method for manufacturing a reinforced plate glass according to claim 2, wherein the core plate glass and the surface-layer plate glass are melt-bonded by down-draw under a state in which the core plate glass and the surface-layer plate glass are laminated together.

11. The method for manufacturing a reinforced plate glass according to claim 10, wherein, when the laminated core plate glass and surface-layer plate glass are drawn under heating, the laminated core plate glass and surface-layer plate glass are held at both side edge portions in a width direction by each of rotation rollers aligned at fixed positions in the width direction and are drawn downward by each of the rotation rollers.

12. The method for manufacturing a reinforced plate glass according to claim 11, wherein a drop down rate of the core plate glass and the surface-layer plate glass is changed in association with changing a rotation rate of each of the rotation rollers, to thereby adjust a thickness of a reinforced plate glass finally obtained.

13. The method for manufacturing a reinforced plate glass according to claim 12, wherein a thickness of the reinforced plate glass finally obtained is equal to or less than half a total thickness of the laminated core plate glass and surface-layer plate glass.

14. The method for manufacturing a reinforced plate glass according to claim 2, wherein:
the surface-layer plate glass comprises one plate glass or a laminated plate glass including a plurality of plate glasses being laminated together, and the core plate glass comprises one plate glass or a laminated plate glass including a plurality of plate glasses being laminated together; and
the surface-layer plate glass is arranged on both sides of the core plate glass in a thickness direction.

15. The method for manufacturing a reinforced plate glass according to claim 2, wherein the surface-layer plate glass has a thickness equal to or less than one third of the thickness of the core plate glass.
